(19) United States
(12) Patent Application Publication
(10) Pub. No.: US 2005/0157740 A1
(43) Pub. Date: Jul. 21, 2005

(54) Wireless communication device, interference source estimation method and channel selection method

(76) Inventor: Shigeo Sato, Tokyo (JP)

Correspondence Address: INTELLECTUAL PROPERTY / TECHNOLOGY LAW, PO BOX 14329, RESEARCH TRIANGLE PARK, NC, 27709, US

(21) Appl. No.: 10/916,750

(22) Filed: Aug. 12, 2004

(30) Foreign Application Priority Data
Jan. 7, 2004 (JP) 2004-002291

(51) Int. Cl. H04L 12/28

(52) U.S. Cl. 370/431

(57) ABSTRACT

An object of the present invention is to reduce radio wave interference between a wireless communication devices and an interference source that is present in an interference area of the wireless communication device by estimating the interference source. In order to achieve this object, the wireless communication device according to the present invention is a wireless communication device that performs wireless communications by selecting any one channel among a plurality of pre-established channels, comprising: a judgment unit that judges whether or not an interference source, which radiates interfering radio waves in a frequency band contained in a bandwidth that is wider than the frequency bandwidth within which the plurality of channels is distributed, is present; an estimation unit that estimates the interference source by analyzing the frequency spectrum of the interfering radio waves; and a channel selection unit that makes a channel selection such that the priority ranking of the channel containing the frequency of the interfering radio waves is low among the plurality of channels.

### CROSS-REFERENCE TO RELATED APPLICATION

This application claims priority under 35 USC §119 of Japanese Patent Application No. 2004-002291 filed Jan. 7, 2004.

### BACKGROUND OF THE INVENTION

1. Field of the Invention

The present invention relates to an interference source estimation technology for estimating an interference source that exists in an interference area of a wireless communication device, and to a channel selection technology that selects a communication channel based on the result of the interference source estimation.

2. Description of the Related Art

In the 2.4 GHz band, radio wave usage is regulated as the ISM band. Therefore wireless LAN systems, microwave ovens, microwave medical equipment, low-pressure dryers, shoplifting prevention systems, POS terminals, moving body discrimination systems, and so forth, use this frequency band, and hence radio wave interference arises between cordless phones and these radio wave sources. In order to avoid this interference with conventional cordless phones, (1) a method that makes RSSI measurements at a communication frequency determined by establishing beforehand whether the interference source radiates radio waves at the time of a link request exchanged between a parent device and a child device, and then transmits a link request at the frequency with the lowest RSSI, and (2) a method that communicates by making an RSSI measurement at fixed intervals, such as when a call is not being made, with respect to each channel for which cordless phone usage is scheduled, and then searches for the channel with the lowest RSSI is conducted, have been performed.

However, with the method in (1), there are frequent cases where a cordless phone is easily subjected to interference when an interference source interrupts the communication channel while the cordless phone is making a call. More particularly, in the case of a wireless LAN system or the like, when the amount of communication is small, the number of packets used for the communication is also small. Therefore, when the average is taken of the measured RSSI to determine a value per unit interval, this value is small, and there are frequent cases where the presence of the interference source is not discovered and is not noticed. In addition, with the method in (2), when the RSSI is measured at long intervals with respect to an interference source with a relatively small usage frequency such as a microwave oven, the average value of the RSSI per unit interval is then small and the presence of the interference source often goes unnoticed. Therefore, with conventional methods, even when the presence of an interference source can be detected at a certain instant, there is no effective detection method for actually making a call using a cordless phone and hence interference is often received during a call. When interference is received during a call, this is the main cause of a drop in call quality because the call is temporarily interrupted by a channel variation or the like.

### SUMMARY OF THE INVENTION

Accordingly, an object of the present invention is to propose a wireless communication device that reduces radio wave interference by estimating an interference source present in an interference area of the wireless communication device, and an interference source estimation method and channel selection method.

In order to achieve this object, the wireless communication device according to the present invention is a wireless communication device that performs wireless communications by selecting any one channel among a plurality of pre-established channels, comprising: a judgment unit that judges whether or not an interference source, which radiates interfering radio waves in a frequency band contained in a bandwidth that is wider than the frequency bandwidth within which the plurality of channels is distributed, is present; an estimation unit that estimates the interference source by analyzing the frequency spectrum of the interfering radio waves; and a channel selection unit that makes a channel selection such that the priority ranking of the channel containing the frequency of the interfering radio waves is low among the plurality of channels. The frequency spectrum of the interfering radio waves radiated by the interference source has a characteristic that is specific to the interference source, and therefore the interference source can be estimated by analyzing the frequency spectrum of the interfering radio waves. By lowering the priority ranking for selecting the channel containing the frequency band used by the interference source, the wireless communication device is able to perform wireless communications without receiving radio wave interference from the interference source.

The interference source estimation method according to the present invention is an interference source estimation method for estimating an interference source radiating interfering radio waves in at least any channel among a pre-established plurality of channels, comprising the steps of: judging whether or not an interference source, which radiates interfering radio waves in a frequency band contained in a bandwidth that is wider than the frequency bandwidth within which the plurality of channels is distributed, is present; and estimating the interference source by analyzing the frequency spectrum of the interfering radio waves when it is judged that the interfering radio waves are present. Since the frequency spectrum of interfering radio waves radiated by the interference source has a characteristic that is specific to the interference source, the interference source can be estimated by analyzing the frequency spectrum of the interfering radio waves.

The channel selection method according to the present invention is a channel selection method that selects a channel for performing wireless communications among a pre-established plurality of channels, comprising the steps of: judging whether or not an interference source, which radiates interfering radio waves in a frequency band contained in a bandwidth that is wider than the frequency bandwidth within which the plurality of channels is distributed, is present; estimating the interference source by analyzing the frequency spectrum of the interfering radio waves when it is judged that the interfering radio waves are present; and making a channel selection such that the priority ranking of the channel containing the frequency of the interfering radio waves is low among the plurality of channels. By lowering the priority ranking for selecting the channel containing the frequency bandwidth used by the interference source, radio wave interference between the wireless communication devices and the interference source can be avoided.

### BRIEF DESCRIPTION OF THE DRAWINGS

FIG. 1 is a constitutional view of the cordless phone of this embodiment;

FIG. 2 shows the timing for measuring the RSSI of the interfering radio waves;

FIG. 3 is a constitutional view of a sampling circuit; and

FIG. 4 is the frequency spectrum of a wireless LAN system.

### DESCRIPTION OF THE PREFERRED EMBODIMENTS

An embodiment will be described hereinbelow with reference to the drawings.

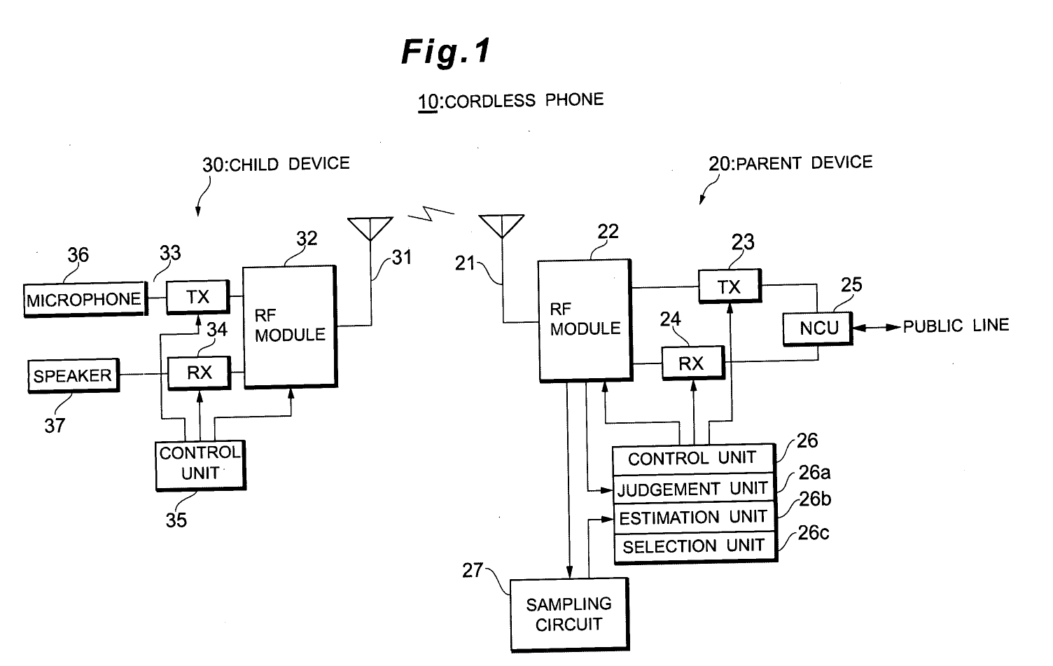

FIG. 1 shows the function blocks of the cordless phone pertaining to this embodiment.

The cordless phone 10 is constituted comprising a parent device 20 and a child device 30. The parent device 20 is connected to a public line via a network control unit (NCU) 25. After subjecting a speech signal sent by the public line to amplification processing and so forth by means of a transmission-processing unit (TX) 23, the parent device 20 modulates the amplified speech signal by means of a high frequency (RF) module 22 and transmits the modulated speech signal to the child device 30 via an antenna 21. In addition, after receiving, via the antenna 21, wireless radio waves that are sent by the child device 30, the parent device 20 demodulates these wireless radio waves by means of the RF module 22 before subjecting this signal to amplification or other processing by means of a reception processing unit (RX) 24 and outputting the processed signal to the network control unit 25. The RF module 22, transmission-processing unit 23, and reception-processing unit 24 are controlled by a control unit 26. Meanwhile, in addition to comprising an antenna 31, RF module 32, transmission processing unit 33, reception processing unit 34, and control unit 35 as does the parent device 20, the child device 30 further comprises a microphone 36 and a speaker 37 that constitute a transceiver.

Wireless communications between the parent device 20 and child device 30 are undertaken by selecting any one channel with a favorable communication state among a plurality of channels that have been pre-established by a standard or the like. Channel selection estimates the interference source by means of the interference source estimation method described below, and performs setting so that the priority ranking of the channel containing the frequency of the interfering radio waves, or that of a nearby channel, is low.

(1) Pre-sampling of the Interference Source

First, as a first stage of the interference source estimation, RSSI measurement is performed and a check is made of whether an interference source is present in the wireless environment. More particularly, in order to use the cordless phone 10 in a frequency bandwidth within which various wireless device channel bandwidths are mixed as is the case with the ISM band, the RSSI measurement frequency and measurement cycle are desirably adjusted by assuming the characteristics of individual interference sources beforehand. For example, where the RSSI measurement frequency is concerned, the RSSI measurement is preferably performed in a bandwidth that is wider than the frequency bandwidth within which the channels used by the cordless phone 10 are distributed. Therefore, by extending the RSSI measurement frequency to a wide bandwidth, a search to establish the presence or absence of a wireless system that only communicates in bursts by using a wide bandwidth as is the case for a wireless LAN system can be conducted. Further, where the RSSI measurement cycle is concerned, RSSI measurements are preferably performed intermittently at relatively long intervals (every 10 seconds or every minute, for example). Because a microwave oven or similar is not used for one minute or less, an accurate search to determine the presence of absence of an interference source can be conducted by moderately adjusting the RSSI measurement cycle.

The interference source pre-sampling may be performed by either the parent device 20 or the child device 30. Normally, the parent device 20 operates by receiving a supply of power from an external power supply (AC supply) and the child device 30 operates by receiving a supply of power from an internal battery. Although there is a certain degree of electrical power consumption in a non-call state because both these devices mutually scan link requests from partners at fixed intervals, the parent device 20 receives a supply of power from an external power supply and hence the electrical power consumption resulting from RSSI measurement that is directed toward interference source pre-sampling is not as serious as that of the child device 30. In this embodiment, RSSI measurement means that are directed toward interference source pre-sampling are mounted in the parent device 20. More specifically, as shown in FIG. 1, the control unit 26 receives the RSSI from the RF module 22 and functions as a judgment unit 26a that judges the existence of the interference source when the RSSI exceeds a predetermined threshold value.

(2) Interference Source Estimation

When it is judged in the above pre-sampling that an interference source is present, the frequency spectrum of the interfering radio waves is analyzed to estimate the interference source as the second stage of the interference source estimation. In the case of an interference source such as a low-power data communication system (a wireless LAN system, for example), an ISM device (devices that use a magnetron such as a microwave oven, high-frequency medical equipment, a low-pressure dryer, a shoplifting prevention system, for example), a moving body discrimination system, or amateur radio, the frequency spectrum of the interfering radio waves also has individual characteristics according to the characteristics of each device. Therefore, the interference source can be estimated by analyzing the RSSI frequency distribution. However, when the cordless phone 10 adopts the DS-SS method, an interference source that adopts the FH-SS method has very little effect on the cordless phone 10. This kind of interference source is therefore not considered in the following description.

In order to sample the frequency spectrum of the interfering radio waves, a plurality of RSSI measurement channels is set and the RSSI of the interfering radio waves must be measured for each of the measurement channels. There are no particular restrictions on the RSSI measurement channel setting method. An RSSI measurement channel setting method that focuses on the 2.4-GHz wireless LAN system usage bandwidth is illustrated here. If such settings are made, because the 2.4-GHz wireless LAN system usage bandwidth spans substantially the entire ISM band, the frequency spectrum of other ISM devices is measured at the same time. When fifteen channels are allocated to each 5 MHz from the 2402 MHz as RSSI measurement channels, the RSSI can be measured by further dividing the channel bandwidth for each of channels 1 to 11 constituting the wireless LAN channels into 5 parts. In addition, when a channel is allocated to each 10 MHz from the 2402 MHz, the RSSI can also be measured by further dividing the channel bandwidth into two to three parts for each channel.

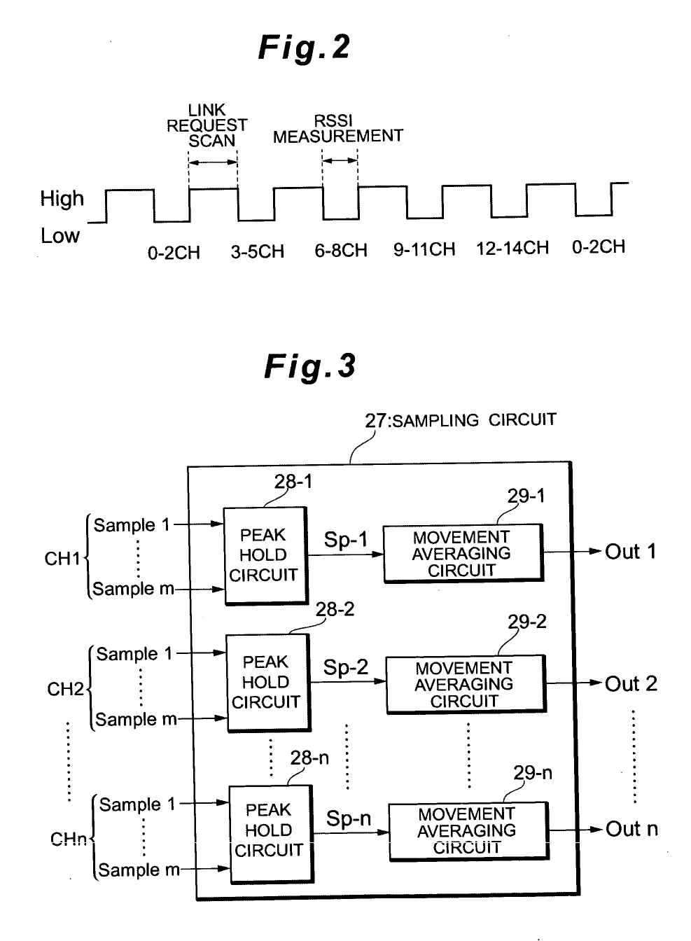

FIG. 2 shows the RSSI measurement timing. As mentioned above, the parent device 20 performs scanning at fixed intervals in order to search for link requests from the child device 30. The RSSI measurement of the interfering radio waves is performed at times when link request scanning is not being performed by the parent device 20. In FIG. 2, segments when the signal is High indicate segments when a link request scan is being performed, and segments when the signal is Low indicate segments when RSSI measurement is being performed. The link interval of the wireless LAN system is sufficiently longer than the interval required for a link request scan by the parent device 20, and hence there is very little need for the RSSI measurement of interfering radio waves radiated by the wireless LAN system (interference source) to be performed at the same time for all the RSSI measurement channels. Therefore, in this embodiment, the RSSI measurement is performed on three channels as shown in FIG. 2.

As shown in FIG. 1, the parent device 20 comprises a sampling circuit 27 for sampling the RSSI of the interference source measured in each RSSI measurement channel. The control unit 26 analyzes the RSSI frequency distribution (frequency spectrum) from the output data of each RSSI measurement channel supplied by the sampling circuit 27 and function is an estimation unit 26b that estimates the interference source from the frequency distribution. The circuit constitution of the sampling circuit 27 is shown in FIG. 3. In this figure, CH1 to CHn denote n RSSI measurement channels that are set in order to estimate wireless LAN system usage channels. The RSSI measurement performs the measurement for each channel m times by considering the scatter, and the peak values Sp_1 to Sp_n are rendered the RSSI of these channels and are latched by peak hold circuits 28-1 to 28-n. These n peak values Sp_1 to Sp_n are averaged by movement averaging circuits 29-1 to 29-n respectively and are outputted as final output data Out_1 to Out_n following noise removal.

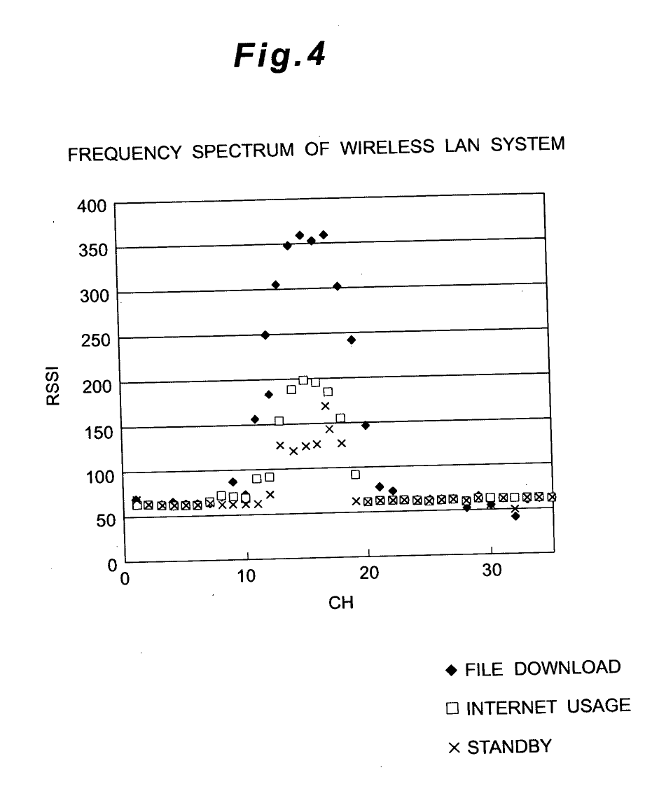

FIG. 4 shows the frequency spectrum of the wireless LAN system. RSSI measurement is performed for 20 minutes with respect to each state, i.e. during a file download, while the Internet is being used, and during standby. There are 35 RSSI measurement channels. One hundred and twenty RSSI measurements are performed for each channel, of which the peak value is sample data (n=35, m=120). As shown in FIG. 4, during a file download, while the Internet is being used, and during standby, the tendency for the RSSI of the specified channel (10 to 20CH) to be larger than that of the other channels does not change and an aspect in which the RSSI of the specified channel increases relatively in step with the load of the wireless LAN system can be confirmed. In the case of a DS-SS method wireless LAN system, the bandwidth that is occupied by a single communication is relatively wide, and, because there is no temporal variation in the transmission frequency of the communication, the frequency range occupied during the communication is easily determined. In addition, the communication channel used by a wireless LAN system is seldom changed after being designated when a device is set. Therefore, once the usage channel of the wireless LAN system has been detected, this channel can be handled as the usage channel until the communication channel is reset.

On the other hand, the frequency spectrum of a microwave oven is not prescribed by the device, and it is known that there is a general tendency for the frequency spectrum to be distributed in uniform fashion with a strong electromagnetic wave level over substantially the whole of the ISM band.

The logic for estimating the interference source from the RSSI sample data will be illustrated below.

(1) A check is made of whether the RSSI of the specified channel indicates a value that is relatively higher than the RSSI of the other channels.

(2) When the RSSI of the specified channel indicates a value that is relatively higher than the RSSI of the other channels and the RSSI of the specified channel increases in step with the load on the wireless LAN system, it can be estimated that the specified channel is the usage channel of the wireless LAN system.

(3) On the other hand, when the RSSI of the specified channel does not indicate a value that is relatively higher than the RSSI of the other channels, it can be estimated that the interference source is a system other than a wireless LAN system.

(4) When the interference source can be estimated as being a system other than a wireless LAN system, if an RSSI of a substantially fixed level with a strong radio wave intensity is detected over a wide bandwidth, the interference source can be estimated as being a microwave oven.

(5) If a frequency spectrum with a discontinuous peak is obtained in a certain frequency band, it can be estimated that this is another system.

Further, if the interference source can be determined by means of the above logic, wireless communications are performed by selecting a channel with the best possible communication state by lowering (setting to the lowest, for example) the priority ranking with which the parent device 20 uses the channel containing the frequency of the interfering radio waves or that of a nearby channel among the plurality of channels in order to reduce radio wave interference as far as possible. As shown in FIG. 1, the control unit 26 functions as a channel selection unit 26c that selects the channel to be used for wireless communications from the interference source estimation result. When the interference source is a wireless LAN system, once the usage frequency has been measured, the wireless LAN is used again in the same frequency bandwidth unless the communication channel settings are changed. Therefore, the priority ranking of the channel containing the usage frequency or that of a nearby channel is preferably fixed at the lowest priority level. When the interference source is a microwave oven, the frequency of the interfering radio waves is not changed and can be fixed while the priority ranking remains reduced.

Therefore, in this embodiment, a study of what kind of interference source is present in the wireless environment where the cordless phone 10 is installed is undertaken, and the cordless phone 10 selects a communication channel so that no interference source or radio wave interference is produced. Therefore, a plurality of systems present in the same interference area can co-exist without interfering with each other.

Although a description was provided in this embodiment by taking the example of the cordless phone 10, the present invention is not limited to or by the cordless phone 10. Rather, the present invention can be applied to wireless communication devices in general that perform wireless communications by selecting any communication channel among a plurality of communication channels.

1. A wireless communication device that performs wireless communications by selecting any one channel among a plurality of pre-established channels, comprising:
a judgment unit that judges whether an interference source, which radiates interfering radio waves in a frequency band contained in a bandwidth that is wider than the frequency bandwidth within which the plurality of channels is distributed, is present;
an estimation unit that estimates the interference source by analyzing the frequency spectrum of the interfering radio waves; and
a channel selection unit that makes a channel selection such that the priority ranking of the channel containing the frequency of the interfering radio waves is low among the plurality of channels.

2. An interference source estimation method for estimating an interference source radiating interfering radio waves in at least any channel among a pre-established plurality of channels, comprising the steps of:
judging whether or not an interference source, which radiates interfering radio waves in a frequency band contained in a bandwidth that is wider than the frequency bandwidth within which the plurality of channels is distributed, is present; and
estimating the interference source by analyzing the frequency spectrum of the interfering radio waves when it is judged that the interfering radio waves are present.

3. A channel selection method that selects a channel for performing wireless communications among a pre-established plurality of channels, comprising the steps of:
judging whether or not an interference source, which radiates interfering radio waves in a frequency band contained in a bandwidth that is wider than the frequency bandwidth within which the plurality of channels is distributed, is present;
estimating the interference source by analyzing the frequency spectrum of the interfering radio waves when it is judged that the interfering radio waves are present; and
making a channel selection such that the priority ranking of the channel containing the frequency of the interfering radio waves is low among the plurality of channels.
